(19) United States
(12) Patent Application Publication
(10) Pub. No.: US 2004/0247800 A1
(43) Pub. Date: Dec. 9, 2004

(54) Projecting film and method of forming the same

(75) Inventors: Tetsuya Yoshitake, Ichihara (JP); Toshifumi Tsujino, Itami (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIPPON SHEET GLASS CO., LTD., Osaka (JP)

(21) Appl. No.: 10/800,084

(22) Filed: Mar. 10, 2004

Related U.S. Application Data
(63) Continuation of application No. PCT/JP02/08950, filed on Sep. 3, 2002.

(30) Foreign Application Priority Data
Sep. 10, 2001 (JP) 2001-273665

(51) Int. Cl. C09K 19/00

(52) U.S. Cl. 428/1.3; 428/141

(57) ABSTRACT

A projecting film enables adhesion to a reflecting film 44 made of an inorganic material to be improved, and alteration of optical properties of the reflecting film 44 to be prevented. A method is provided for forming such a projecting film that enables the surface roughness to be controlled freely through few manufacturing steps. A sol-form application liquid in which are mixed metal compounds and solvent(s) is prepared, the prepared sol-form application liquid is applied onto a glass substrate 40 to form a mixed layer 41 on the glass substrate 40, and the mixed layer 41 on the glass substrate 40 is dried, thus evaporating off the solvent(s), and hence bringing about phase separation into an upper layer and a lower layer, whereby an internal scattering layer is formed.

This application is a Continuation Application of International Application No. PCT/JP02/08950 filed Sep. 3, 2002, the entire contents of which are incorporated herein by reference.

### TECHNICAL FIELD

The present invention relates to a projecting film and a method of forming the projecting film, and more particularly to a projecting film of a light-scattering/reflecting substrate suitable for use in a reflection type liquid crystal display apparatus, a semi-transmission type liquid crystal display apparatus, a projection type display transmitting screen, or the like, and a method of forming the projecting film.

### BACKGROUND ART

In recent years, as display means for mobile display apparatuses and the like, reflection type liquid crystal display apparatuses (hereinafter referred to as “reflection type LCDs”) that use reflected natural light or room light (hereinafter referred to collectively as “external light”) and joint reflection/transmission type LCDs (hereinafter referred to as “semi-transmission type LCDs”) that use reflected external light when the amount of external light is high and use light from a backlight when the amount of external light is low have come to be used from the viewpoint of reducing the electrical power consumption of the display means so that a battery of lower capacity can be used.

Images are required to be displayed in full color and with high image quality for mobile display apparatuses used in mobile telephones and portable computers in particular. For example, reflection type LCDs used in such mobile display apparatuses are required to have a high aperture ratio to increase brightness and to display images with no parallax. An internal scattering/reflecting plate form reflection type LCD described in “FPD Intelligence, February 2000 edition (pages 66 to 69)”, for example, is known as a reflection type LCD that satisfies these requirements.

FIG. 3 is a schematic sectional view showing the structure of a conventional internal scattering/reflecting plate form reflection type LCD.

In FIG. 3, the internal scattering/reflecting plate form reflection type LCD 10 is comprised of a pair of glass substrates 1 and 2 that transmit light, a reflecting film 5, described below, that is formed on an inner surface of the glass substrate 2 and scatters incident light 3 and reflects this light as reflected light 4, color filters 6 that are formed on an inner surface of the glass substrate 1 and transmit only light of a certain wavelength (color), and a liquid crystal layer 7 that is filled between the reflecting film 5 and the color filters 6 and controls the transmission of light.

Of the component parts of the internal scattering/reflecting plate form reflection type LCD 10, the glass substrate 2 and the reflecting film 5 together constitute a light-scattering/reflecting substrate 8.

FIG. 4 is a schematic sectional view showing the structure of the light-scattering/reflecting substrate 8 appearing in FIG. 3.

In FIG. 4, the light-scattering/reflecting substrate 8 is comprised of the glass substrate 2, a light-scattering film 11 that is formed on a surface of the glass substrate 2 and has a surface having an undulating shape, and a reflecting film 12 that is formed on the surface of the light-scattering film 11 and has a shape that follows the undulating shape of the light-scattering film 11. The reflecting film 12 reflects incident light, scattering the light due to the undulating shape. The light-scattering film 11 and the reflecting film 12 together constitute the reflecting film 5 described above.

Art for manufacturing such a light-scattering/reflecting substrate is disclosed in, for example, Japanese Patent No. 2698218 and Japanese Laid-open Patent Publication (Kokai) No. 2000-267086, as described below.

First, as first prior art, as shown in FIG. 5, a light-scattering/reflecting substrate manufactured using the manufacturing art disclosed in Japanese Patent No. 2698218 is comprised of a glass substrate 20, an internal scattering layer 21 that is dotted over a surface of the glass substrate 20, and a reflecting film 22 that is formed over the glass substrate 20 and the internal scattering layer 21. This first prior art involves a step of applying a photosensitive resin, which is an organic material, onto one surface of the glass substrate 20, a step of forming a large number of minute projecting parts by patterning the applied photosensitive resin in a predetermined shape, masking, exposing with light and developing, a step of subjecting the glass substrate 20 on which the projecting parts have been formed to heat treatment to round off angular portions of the projecting parts and thus form the internal scattering layer 21, and a step of forming the reflecting film 22, which is made of an inorganic material such as a metallic material or a dielectric material, over the glass substrate 20 and the internal scattering layer 21 by vapor deposition, sputtering or the like.

On the other hand, as second prior art, as shown in FIG. 6, a light-scattering/reflecting substrate manufactured using the manufacturing art disclosed in Japanese Laid-open Patent Publication (Kokai) No. 2000-267086 is comprised of a glass substrate 30, an internal scattering layer 31 that is formed on a surface of the glass substrate 30, and a reflecting film 32 that is formed over the internal scattering layer 31.

The internal scattering layer 31 is comprised of a layer 33 of a first resin, and a plurality of spherical parts 34 that are made of a second resin and are distributed through an upper part of the first resin layer 33. Because the spherical parts 34 are distributed through the upper part of the first resin layer 33, a large number of minute projecting parts are formed on the surface of the internal scattering layer 31. This second prior art involves a step of applying a mixed resin liquid in which are mixed the first resin and the second resin, which are organic substances that readily separate out into separate phases to one another, onto one surface of the glass substrate 30, thus forming a mixed resin layer, a step of making the mixed resin layer undergo phase separation, thus forming the internal scattering layer 31 having the large number of minute projecting parts formed on the surface thereof, and a step of forming the reflecting film 32, which is made of a metallic material, over the internal scattering layer 31 by vapor deposition or sputtering.

However, the first prior art described above is based on a photolithography technique involving steps of applying on a photosensitive resin, masking, exposing with light, developing, carrying out heat treatment and so on, and hence the manufacturing process is complicated and thus the manufacturing cost is high.

On the other hand, the second prior art is based on a photolithography resin phase separation technique, not on a photolithography technique, and hence the problem described above does not occur; nevertheless, the internal scattering layer 31 contains an organic material, and hence there is a problem that adhesion to the reflecting film 32, which is made of an inorganic material such as a metallic material or a dielectric material, is poor, and thus the reflecting film 32 easily peels off. Moreover, when the reflecting film 32 is formed by a vacuum film formation method such as vapor deposition or sputtering, there is a problem that components adsorbed on the surface of the internal scattering layer 31 and unreacted components inside the internal scattering layer 31 are emitted from the internal scattering layer 31 as a gas, thus altering the optical properties (reflectance, refractive index, transmitted color tone etc.) of the reflecting film 32.

Art for manufacturing a thin film having a structure having as a principal skeleton thereof an inorganic material such as a metallic material or a dielectric material that has good adhesion to such a reflecting film 32 made of an inorganic material is disclosed, for example, in Japanese Patent No. 2901833.

The thin film manufactured using this manufacturing art is made from first and second sol solutions each comprised of metal alkoxide compounds (or metal acetylacetonate compounds); a solution in which are mixed the first and second sol solutions is applied onto a glass substrate, thus forming a micropitted surface layer.

However, the size of the diameter of the projecting parts of the thin film formed through this method is controlled by the functional groups and the sizes of the molecular weights for the two selected sol solutions, and projecting parts having a diameter of size greater than approximately 200 nm cannot be formed, and thus it is not possible to use the thin film as an internal scattering layer that scatters visible light (400 to 800 nm).

It is thus an object of the present invention to provide a projecting film that enables adhesion to a reflecting film made of an inorganic material to be improved, and alteration of the optical properties of the reflecting film to be prevented, i.e. a projecting film that contains absolutely no organic materials as constituent materials thereof, and a method of forming such a projecting film that enables the size of the diameter of the projecting parts to be controlled freely through few manufacturing steps.

### SUMMARY OF THE INVENTION

To attain the above object, a projecting film of the present invention, which is formed on a substrate and has a large number of projecting parts by phase separation, is characterized by being made of an inorganic material.

Preferably, the projecting film comprises a first phase, and a second phase that is formed on a surface of the first phase and has the projecting parts. Moreover, preferably, the first phase contains a component in which at least one metal compound has been solidified by a gelation reaction, and the second phase contains a component in which at least one second metal compound having a slower gelation reaction rate than the at least one first metal compound has been subjected to a gelation reaction.

Preferably the projecting parts of the projecting film preferably have a diameter larger than the wavelength of visible light.

Preferably the projecting film preferably has an average surface roughness Ra in a range of 10 to 1000 nm, more preferably 10 to 300 nm, yet more preferably 20 to 200 nm.

Preferably, in the case that the projecting film is used on a light-scattering/reflecting substrate of a liquid crystal display apparatus, the projecting film preferably has a maximum surface roughness Rmax of not more than 10 μm, more preferably not more than 3 μm, yet more preferably not more than 1.5 μm.

Preferably, the projecting film preferably has a haze factor not less than 1%, preferably not less than 2%, more preferably not less than 5%.

Preferably the projecting film preferably has a transmitted color tone value, as represented by |a²+b²|, the square of the vector sum of Hunter color coordinates (a,b), of not more than 10, more preferably not more than 5.

Preferably, an angle distribution of scattered transmitted light in response to visible light being perpendicularly incident on the projecting film is preferably within a range of ±20° in terms of solid angle.

Preferably, a scattering angle distribution of reflected light in response to visible light being perpendicularly incident on the projecting film is preferably within a range of ±40° in terms of solid angle from an angle of specular reflection.

Preferably, it is preferable for the projecting film to be used as an internal scattering layer disposed in a reflection type liquid crystal display apparatus or a semi-transmission type liquid crystal display apparatus.

Preferably, it is also preferable for the projecting film to be used as an anti-glare film, or to be formed on a surface of an original-placing window of a copying machine or a side window of an automobile.

To attain the above object, a method of forming a projecting film of the present invention is characterized by comprising a formation step of forming an applied layer by applying, onto the substrate, a sol-form application liquid having mixed therein at least one first metal compound, at least one second metal compound, and at least one solvent, and a drying step of drying the applied layer to form a large number of projecting parts.

Preferably, the at least one second metal compound preferably has a slower gelation reaction rate than the at least one first metal compound.

Preferably, the at least one second metal compound preferably has a lower wettability than the at least one first metal compound.

Preferably, at least one solvent out of the at least one solvent is preferably a single solvent selected from the group consisting of straight-chain glycols having a hydroxyl group at each end thereof represented by the general formula HO—(CH₂)ₙ—OH wherein 2≦n≦10, and polyhydric alcohols represented by the general formula HO—(CH₂)ₙ(CHOH)ₘ—OH wherein n≧2 and m≧1, or a mixed solvent thereof.

Preferably, each of the at least one first metal compound and the at least one second metal compound is preferably a metal compound capable of undergoing a hydrolysis/condensation polymerization reaction.

Preferably, each of the at least one first metal compound and the at least one second metal compound is preferably an alkoxide of a metal selected from the group consisting of silicon, aluminum, titanium, zirconium and tantalum.

### BRIEF DESCRIPTION OF THE DRAWINGS

FIG. 1 is a flowchart of a process for manufacturing a light-scattering/reflecting substrate having a projecting film according to an embodiment of the present invention; a

FIGS. 2A to 2C are views useful in explaining the process for manufacturing a light-scattering/reflecting substrate according to the present invention; specifically:

FIG. 2A shows a mixed layer formation step;

FIG. 2B shows an internal scattering layer formation step; and

FIG. 2C shows a reflecting film formation step;

FIG. 3 is a schematic sectional view showing the structure of a conventional internal scattering/reflecting plate form reflection type LCD;

FIG. 4 is a schematic sectional view showing the structure of a light-scattering/reflecting substrate 8 appearing in FIG. 3;

FIG. 5 is a sectional view of a light-scattering/reflecting substrate according to first prior art; and

FIG. 6 is a sectional view of a light-scattering/reflecting substrate according to second prior art.

### DETAILED DESCRIPTION OF DRAWINGS

A method of forming a light-scattering/reflecting substrate having a projecting film according to an embodiment of the present invention will now be described in detail with reference to the drawings.

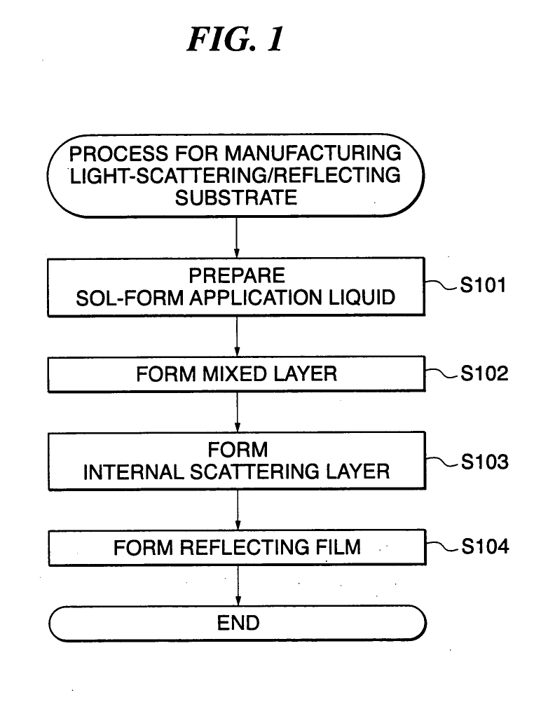

FIG. 1 is a flowchart of a process for manufacturing a light-scattering/reflecting substrate having a projecting film according to a first embodiment of the present invention.

The present process is carried out to manufacture a light-scattering/reflecting substrate suitable for use in a reflection type LCD, a semi-transmission type LCD or the like at low cost and to high quality using a sol-gel method, described below.

In general, the sol-gel method is a method in which a solution of organic or inorganic compound(s) of metal(s) is prepared, a hydrolysis/condensation polymerization reaction of the compound(s) in the solution is made to proceed so that the sol solidifies into a gel, and then the gel is heated to produce solid oxide(s).

In the gelation reaction, the metal compound(s) undergo a condensation polymerization reaction with loss of water, and thus polymerization occurs in which a metal-oxygen-metal network is formed.

If the sol-gel method described above is used, then a projecting film can be formed through only a couple of steps, specifically an applied layer formation step and a drying step, and hence the manufacturing cost can be reduced.

In FIG. 1, a sol-form application liquid in which are mixed metal compounds and solvent(s) is first prepared (step S101).

Alkoxides of metals selected from the group consisting of silicon, aluminum, titanium, zirconium and tantalum can be used as the metal compounds mixed into the sol-form application liquid. Such metal alkoxides are readily obtainable, are stable at normal temperatures and pressures, and are non-toxic, and thus enable the internal scattering layer manufacturing process to be simplified and hence the manufacturing cost to be reduced. In addition, such metal alkoxides do not absorb light in the visible region, and hence transmitted light is not colored, and thus it is possible to form a projecting film ideal for use in a transmission mode.

Moreover, as at least one of the solvent(s) mixed into the sol-form application liquid, it is effective to use a single solvent selected from the group consisting of straight-chain glycols having a hydroxyl group at each end thereof represented by the general formula HO—(CH₂)ₙ—OH wherein 2≦n≦10, and polyhydric alcohols represented by the general formula HO—(CH₂)ₙ(CHOH)ₘ—OH wherein n≧2 and m≧1, or a mixed solvent thereof, wherein this solvent has a high surface tension (e.g. not less than 30 dyn/cm). It is empirically known that by using such solvent(s), phase separation of the plurality of metal compounds can be carried out efficiently.

Furthermore, as other solvent(s) mixed into the sol-form application liquid, alcohols including methanol, ethanol, propanol and butanol, ketones including acetone and acetylacetone, esters including methyl acetate, ethyl acetate and propyl acetate, cellosolves including butyl cellosolve, and s on o can be used.

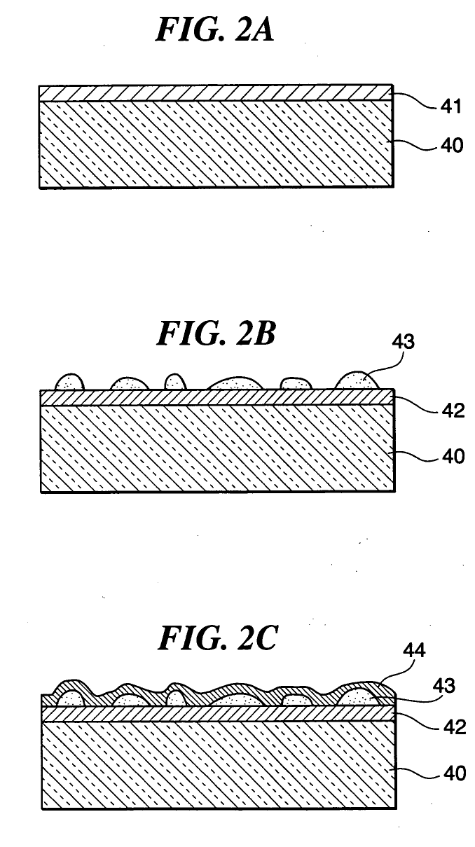

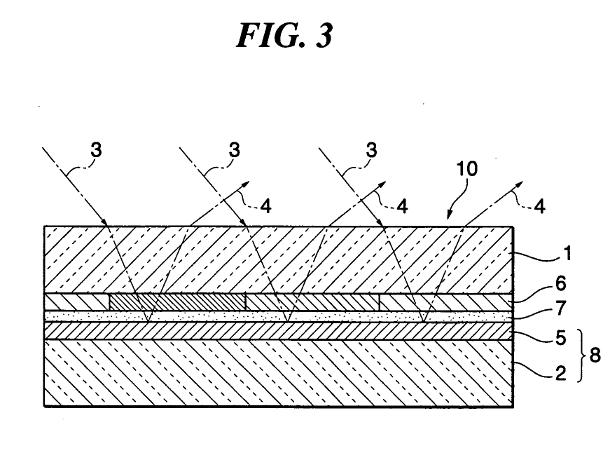

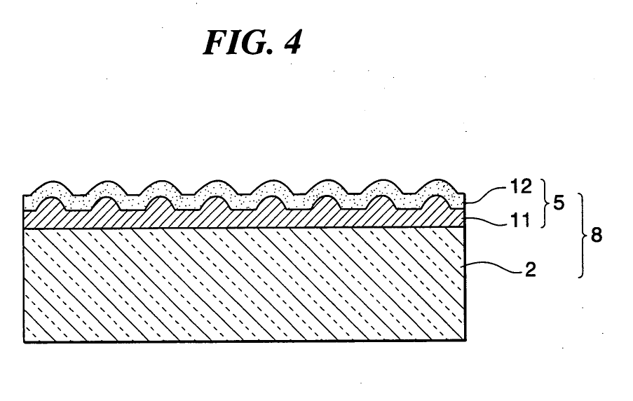

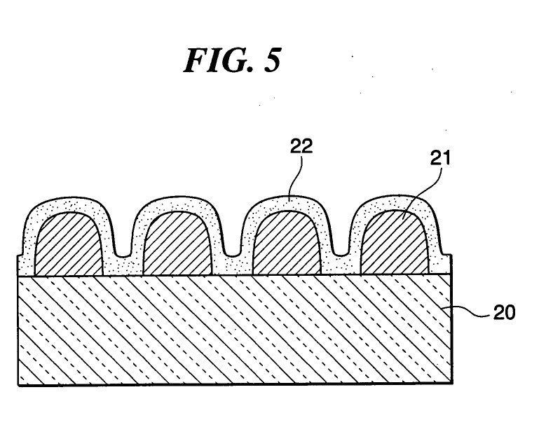

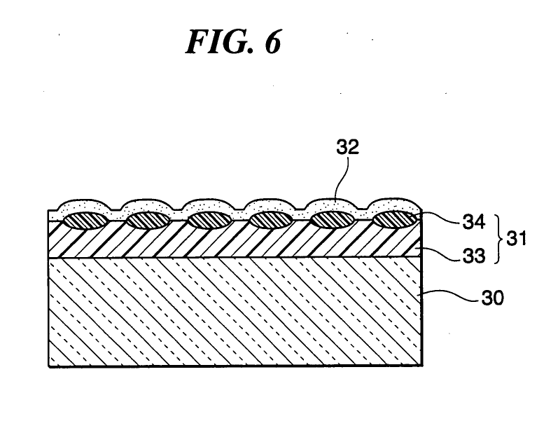

Next, in step S102, the sol-form application liquid prepared in step S101 is applied onto a surface of a glass substrate 40, thus forming a mixed layer 41 (FIG. 2A).

A known technique can be used as the method of applying the sol-form application liquid, for example a method using an apparatus such as a spin coater, a roll coater, a spray coater or a curtain coater, a dip coating method, a flow coating method, or any of various printing methods such as screen printing or gravure printing can be used.

Next, in step S103, the mixed layer 41 is dried (the solvent(s) contained in the sol-form application liquid is/are evaporated off), thus forming an internal scattering layer having a large number of projecting parts on the surface of the glass substrate 40. The method of drying the mixed layer 41 should be such that the solvent(s) in the sol-form application liquid can be evaporated off. For example, air drying, or a method in which the mixed layer 41 is heated to at least 100° C. may be used, or in the case that the boiling point is high and the evaporation rate is slow for the solvent(s), a method of heating to at least 200° C. may be used.

When the mixed layer 41 is dried using any of the above drying methods, through the projecting part formation mechanism described below, phase separation of the plurality of metal compounds proceeds, and hence a large number of projecting parts appear on the surface of the mixed layer 41, and thus the mixed layer 41 becomes an internal scattering layer having a light scattering function.

Regarding the mechanism by which the projecting parts are formed, many aspects are unclear, but the present inventors have hypothesized the following.

If the rate of hydrolysis/condensation polymerization (hereinafter referred to as the “gelation reaction rate”) is different for each of the plurality of metal compounds in the mixed layer 41, then solidification through the gelation reaction will start selectively for the metal compound(s) for which -the gelation reaction rate is fastest (hereinafter referred to as the “A group”) out of the plurality of metal compounds, and the A group metal compound(s) will solidify in a flat shape, thus forming an A phase 42 on the surface of the glass substrate 40 (FIG. 2B).

Moreover, when the A phase 42 solidifies, the other metal compound(s) for which the gelation reaction rate is slower than for the A group (hereinafter referred to as the “B group”) will exude out as droplets on the surface of the A phase 42. At this time, if the wettability is lower for the B group metal compound(s) than for the A group metal compound(s), then the B group metal compound(s) that have exuded out will then start to solidify through the gelation reaction while still maintaining their droplet shape, and hence the B group metal compound(s) will solidify as a B phase 43 having a projecting shape (FIG. 2B).

At this time, the projecting shape of the internal scattering layer formed is not necessarily such that the A phase 42 is exposed as shown in FIG. 2B, but may instead be such that the whole of the surface of the A phase 42 is covered by the B phase 43. In either case, if the diameter of the projecting parts of the projecting film is larger than the wavelength of visible light, then it will be possible to use the projecting film as an internal scattering layer that scatters visible light.

The size of the diameter of the projecting parts can be controlled through few steps merely be selecting the thickness of application of the sol-form application liquid; by controlling the size of the diameter of the projecting parts to be larger than the wavelength of visible light using this method, it will be possible to use the projecting film as an internal scattering layer.

Moreover, as another method of controlling the diameter of the projecting parts, the gelation reaction rate may be controlled by using an acid catalyst or the like during the metal alkoxide hydrolysis/condensation polymerization reaction, and the concentration of the acid catalyst, the reaction time and so on may be controlled to control the gelation reaction rate.

Moreover, the component formed by solidification through the gelation reaction of the metal compound(s) having a fast gelation reaction rate (the A group) is rich in the A phase 42, and the component formed by solidification through the gelation reaction of the metal compound(s) having a slow gelation reaction rate (the B group) is rich in the B phase 43; nevertheless, it is not necessary to carry out strict phase separation of the A group metal compound(s) and the B group metal compound(s) into the A phase 42 and the B phase 43 respectively, but rather the A phase 42 may contain the B group metal compound(s) to some extent and the B phase 43 may contain the A group metal compound(s) to some extent.

In FIG. 1, a reflecting film 44 is next formed over the internal scattering layer that was formed in step S103 (step S104, FIG. 2C), thus completing the present manufacturing process.

The reflecting film 44 is formed to a uniform thickness over the internal scattering layer having the projecting shape, and hence the reflecting film 44 also exhibits a projecting shape.

A thin metal film, or a thin dielectric film having a reflectance of at least 50% can be used as the reflecting film 44.

In the case of using a thin metal film as the reflecting film 44, the material thereof is selected from aluminum, silver, and alloys having these metals as a principal component thereof; the thin metal film may be comprised of either a single layer or a plurality of layers made of different metallic materials.

On the other hand, in the case of using a thin dielectric film as the reflecting film 44, the reflecting film 44 is formed as a multi-layer film in which are formed a plurality of sets each comprised of a low-refractive-index layer and a high-refractive-index layer. Silicon oxide or magnesium fluoride is predominantly used as the material of the low-refractive-index layers, and titanium oxide or tantalum oxide is predominantly used as the material of the high-refractive-index layers. Such a thin dielectric film is suitable for use as a semi-transmitting film since there is no optical absorption.

Moreover, in the case of realizing a semi-transmission type LCD that exhibits bright displayed images by concentrating external light in the viewing direction, it is preferable for the internal scattering layer to exhibit a reflected light scattering angle distribution within a range of ±40° in terms of solid angle from the angle of specular reflection, and a transmitted light scattering angle distribution within a range of ±20° in terms of solid angle.

The projecting film is suitable for use as an internal scattering layer provided in a reflection type LCD or a semi-transmission type LCD, but since back-scattering is not prone to occurring, may also be used on a transmitting/diffusing plate provided in a rear projection type TV display or the like. Moreover, because the reflectance of light can be controlled, the projecting film may also be used as an anti-glare film, or may be used on a low-friction plate by being formed on the surface of an original-placing window of a copying machine, a side window of an automobile or the like.

### EXAMPLES

A concrete description will now be given of examples of the present invention.

### Example 1

20 g of ethyl silicate 40 (made by Colcoat), which is a silicon alkoxide, as a first metal compound, 3.6 g of 0.1N hydrochloric acid as a catalyst, and 16.4 g of ethyl cellosolve (2-ethoxyethanol, made by Kanto Kagaku) as a solvent were mixed together, and the mixture was agitated for 24 hours at room temperature, thus preparing a silicon compound stock solution X.

17.6 g of tetraisopropyl orthotitanate, which is a titanium alkoxide, as a second metal compound, and 12.4 g of acetylacetone as a chelating agent were mixed together, and the mixture was agitated for 24 hours at room temperature, thus preparing an acetylacetone-chelated titanium compound stock solution X.

Next, 3.75 g of the silicon compound stock solution X, 4.55 g of the titanium compound stock solution X, and 10 g of ethylene glycol and 31.7 g of ethyl cellosolve as solvents were mixed together, and the mixture was agitated, thus preparing a sol-form application liquid X.

Regarding the composition of the prepared sol-form application liquid X, the solid content was 3.0 mass % assuming that the metal compound raw materials were completely converted to inorganic matter.

The sol-form application liquid X was spin coated for 15 seconds at a rotational speed of 1000 rpm onto one surface of a 100 mm×100 mm×0.5 mm thick soda lime silicate glass substrate.

After that, the glass substrate on which the sol-form application liquid X had been applied was subjected to drying treatment at 300° C. for 3 minutes, thus causing the sol-form application liquid X to undergo a gelation reaction, and hence obtaining an internal scattering layer on the surface of the glass substrate.

The internal scattering layer obtained was subjected to cross-sectional observation using a scanning electron microscope (SEM), whereupon the angle of slope of the projecting parts was in a range of 0 to 4°.

Moreover, the surface roughness was measured by carrying out a 500 μm scan of the surface of the internal scattering layer with a stylus at a speed of 50 μm/s using a stylus type roughness meter (Alpha-Step 500 Surface Profiler made by Tenncore Instruments), whereupon Ra was 31.5 nm and Rmax was 46.3 nm. Furthermore, upon observing with an optical microscope, projecting parts of diameter approximately 3 μm were seen on the surface of the internal scattering layer.

Moreover, the haze factor for the internal scattering layer was measured to be 8.6%, and the transmitted color tone value for the internal scattering layer was measured to be 0.08 ((a, b)=(0.2, −0.2)).

Furthermore, the scattered transmitted light angle distribution for the internal scattering layer was measured by illuminating the internal scattering layer with a standard D65 light source using an instantaneous multi-measurement system (MCPD-1000 made by Otsuka Electronics Co., Ltd.), whereupon the angle range was ±10°, and the reflected light scattering angle range was ±20°.

Next, a reflecting film having a 3-layer structure, in which silicon oxide of thickness 10 nm, metallic aluminum of thickness 85 nm and silicon oxide of thickness 20 nm were built up in this order from the light-scattering film side by sputtering, was deposited onto the surface of the internal scattering layer, whereby a light-scattering/reflecting substrate was obtained.

The reflected light scattering angle distribution was then measured using a variable angle glossimeter (made by Suga Test Instruments Co., Ltd: model UGV-6P). Specifically, the angular dependence of the reflected light when incident light was made to strike the surface of the light-scattering/reflecting substrate at an angle of −30° from the direction of the normal to the surface of the light-scattering/reflecting substrate was measured. The scattering angle distribution, which is the angular range within which the reflected light is uniformly distributed, was measured, with +30°, which is the direction of specular reflection, taken as the center (0°).

The scattering angle range for the light-scattering substrate obtained was ±15°, indicating scattering properties sufficient for practical use.

Moreover, for the light-scattering/reflecting substrate, the adhesion at the interface between the projecting film and the reflecting film formed on the surface thereof, and the adhesion at the interface between the projecting film and the glass substrate, were evaluated using a cross-cut tape peeling evaluation method (JIS K5400 3.5). Specifically, the evaluation was carried out through the number of portions for which peeling did not occur out of 100 portions formed by segmenting with cross cuts into an array of 1 mm×1 mm squares. The result was that, for both the interface between the internal scattering layer and the reflecting film, and the interface between the internal scattering layer and the glass substrate, no peeling was observed at any of the 100 portions.

### Example 2

2.5 g of the silicon compound stock solution X used in Example 1, 3.0 g of the titanium compound stock solution X used in Example 1, and 10 g of ethylene glycol and 34.5 g of ethyl cellosolve as solvents were mixed together, and the mixture was agitated, thus preparing a sol-form application liquid Y.

Regarding the composition of the prepared sol-form application liquid Y, the solid content was 2.0 mass % assuming that the metal compound raw materials were completely converted to inorganic matter.

The sol-form application liquid Y was spin coated for 15 seconds at a rotational speed of 1000 rpm onto one surface of a 100 mm×100 mm×0.5 mm thick soda lime silicate glass substrate.

After that, the glass substrate on which the sol-form application liquid Y had been applied was subjected to drying treatment at 300° C. for 3 minutes, thus causing the sol-form application liquid Y to undergo a gelation reaction, and hence obtaining an internal scattering layer on the surface of the glass substrate.

The internal scattering layer obtained was subjected to cross-sectional observation using a scanning electron microscope (SEM), whereupon the angle of slope of the projecting parts was in a range of 0 to 3°.

Moreover, the surface roughness was measured using the same method as in Example 1, whereupon Ra was 25.5 nm and Rmax was 36.3 nm. Furthermore, upon observing with an optical microscope, projecting parts of diameter approximately 2 μm were seen on the surface of the internal scattering layer.

Moreover, the haze factor for the internal scattering layer was measured to be 6.2%, and the transmitted color tone value for the internal scattering layer was measured to be 0.05 ((a, b)=(0.2, −0.1)).

Furthermore, the scattered transmitted light angle distribution was measured using the same method as in Example 1, whereupon the angle range was ±8°, and the reflected light scattering angle range was ±15°, indicating scattering properties sufficient for practical use.

Next, a reflecting film having a 3-layer structure was deposited onto the surface of the internal scattering layer using the same method as in Example 1, whereby a light-scattering/reflecting substrate was obtained.

The scattering angle range was then measured using the same method as in Example 1, whereupon the measured scattering angle range was ±10°, indicating scattering properties sufficient for practical use.

Moreover, for the light-scattering/reflecting substrate, the adhesion at the interface between the projecting film and the reflecting film formed on the surface thereof, and the adhesion at the interface between the projecting film and the glass substrate, were evaluated using the cross-cut tape peeling evaluation method as in Example 1. The result was that, for both the interface between the internal scattering layer and the reflecting film, and the interface between the internal scattering layer and the glass substrate, no peeling was observed at any of the 100 portions formed by segmenting with cross cuts into an array of 1 mm×1 mm squares.

### Comparative Example 1

7.5 g of the silicon compound stock solution X used in Example 1, and 10 g of ethylene glycol and 32.5 g of ethyl cellosolve as solvents were mixed together, and the mixture was agitated, thus preparing a sol-form application liquid U.

Regarding the composition of the prepared sol-form application liquid U, the solid content was 3.0 mass % assuming that the metal compound raw material was completely converted to inorganic matter.

The sol-form application liquid U was spin coated for 15 seconds at a rotational speed of 1000 rpm onto one surface of a 100 mm×100 mm×0.5 mm thick soda lime silicate glass substrate.

After that, the glass substrate on which the sol-form application liquid U had been applied was subjected to drying treatment at 300° C. for 3 minutes, thus causing the sol-form application liquid U to undergo a gelation reaction, and hence obtaining an internal scattering layer on the surface of the glass substrate.

The internal scattering layer obtained was subjected to cross-sectional observation using a scanning electron microscope (SEM), whereupon it was found that a projecting film had not been formed, but rather a flat film had been formed. It was surmised that this was because the sol-form application liquid U was made to contain only one metal compound, and hence phase separation did not occur.

Furthermore, the scattered transmitted light angle distribution was measured using the same method as in. Example 1, whereupon it was found that the angle range was extremely narrow at approximately ±1°, i.e. that light transmitted through the internal scattering layer was hardly scattered at all. Moreover, it was found that the reflected light scattering angle range was also extremely narrow at approximately ±3°, i.e. that reflection from the internal scattering layer was virtually specular.

From the above results, it was found that the internal scattering layer obtained in Comparative Example 1 exhibited optical properties not sufficient for practical use.

### Comparative Example 2

A film of a photosensitive resin (made by Tokyo Ohka Kogyo Co., Ltd.: product name OFPR-800) was formed by spin coating to a thickness of 1.2 μm onto one surface of a 100 mm×100 mm×0.5 mm thick soda lime silicate glass substrate.

After that, the glass substrate on which the photosensitive resin had been applied was prebaked at 100° C. for 30 seconds, and then UV exposure was carried out using a photomask.

The photomask used had a pattern in which circular transparent parts of diameter 6 μm were arranged at random.

Next, development was carried out using a developer (made by Tokyo Ohka Kogyo Co., Ltd.: product name NMD-3), thus forming minute cylindrical projecting parts on the surface of the glass substrate, and then heating was carried out at 200° C. for 60 minutes, thus rounding off angular portions of the projecting parts.

The photosensitive resin was then further spin coated to a thickness of 0.3 μm onto the glass substrate having the rounded minute projecting parts formed thereon, and then heating was carried out at 200° for 60 minutes, thus further rounding off the angular portions of the projecting parts, and hence completing the formation of an internal scattering layer on the surface of the glass substrate.

For the glass substrate having the internal scattering layer obtained, the cross section of the internal scattering layer was observed using an SEM as in Example 1. The result was that the angle of slope of the projecting parts was in a range of 0 to 8°.

Furthermore, the scattered transmitted light angle distribution was measured using the same method as in Example 1, whereupon the angle range was approximately ±20°, and the reflected light scattering angle range was approximately ±40°, i.e. practical use as an internal scattering layer was possible.

Next, a reflecting film having a 3-layer structure as in Example 1 was deposited by sputtering onto the surface of the internal scattering layer obtained, whereby a light-scattering/reflecting substrate was obtained. For the light-scattering/reflecting substrate, the adhesion at the interface between the internal scattering layer and the reflecting film was evaluated using the cross-cut tape peeling evaluation method as in Example 1.

The result was that the number of portions for which peeling did not occur out of 100 portions formed by segmenting with cross cuts into an array of 1 mm×1 mm squares was only 30 for the interface between the internal scattering layer and the reflecting film, i.e. it was found that the adhesion was extremely low, and hence that practical industrial use would not be possible. It was surmised that this was because the light-scattering film was made of an organic material.

The above results are collected together in Table 1. As shown by the various properties for Examples 1 and 2, the internal scattering layer, i.e. the projecting film, according to an embodiment of the present invention exhibits a scattered transmitted light angle distribution and a reflected light scattering angle distribution enabling practical use better than with Comparative Example 1, and moreover exhibits better adhesion at the interface between the internal scattering layer and the reflecting film than with Comparative Example 2.

TABLE 1

| | EXAMPLE | | COMPARATIVE EXAMPLE | |
|---|---|---|---|---|
| | 1 | 2 | 1 | 2 |
| ANGLE OF SLOPE OF | 0˜4° | 0˜3° | FLAT FILM | 0˜8° |
| PROJECTING PARTS | | | FORMED | |
| Ra | 31.5 nm | 25.5 nm | — | — |
| Rmax | 46.3 nm | 36.3 nm | — | — |
| DIAMETER OF PROJECTING | APPROX. 3 mm | APPROX. 2 mm | — | APPROX. 6 mm |
| PARTS | | | | |
| HAZE FACTOR | 8.6% | 6.2% | — | — |
| TRANSMITTED COLOR TONE | 0.08 | 0.05 | — | — |
| VALUE | | | | |
| TRANSMITTED LIGHT | ±10° | ±8° | ±1° | ±20° |
| SCATTERING ANGLE RANGE | | | | |
| REFLECTED LIGHT | ±20° | ±15° | ±3° | ±40° |
| SCATTERING ANGLE RANGE | | | | |
| REFLECTED LIGHT | ±15° | ±10° | — | — |
| SCATTERING ANGLE RANGE | | | | |
| AFTER MIRROR FILM | | | | |
| NO. OF PORTIONS WHERE | 0 | 0 | — | 70 |
| PEELING OCCURRED (CROSS- | | | | |
| CUT TAPE PEELING | | | | |
| EVALUATION METHOD) | | | | |

### INDUSTRIAL APPLICABILITY

As described in detail above, according to the projecting film of the present invention, the projecting film, which is formed on a substrate and has a large number of projecting parts by phase separation, is made of an inorganic material. As a result, adhesion to a reflecting film made of an inorganic material such as a metal or a dielectric material can be improved, and alteration of optical properties of the reflecting film can be prevented.

Moreover, according to the projecting film of the present invention, the projecting film is comprised of a first phase formed on the substrate, and a second phase that is formed on a surface of the first phase and has the projecting parts. As a result, in addition to the above effects, a projecting shape suitable for scattering reflected light can be exhibited.

Moreover, according to the projecting film of the present invention, the first phase contains a component in which at least one first metal compound has been solidified by a gelation reaction, and the second phase contains a component in which at least one second metal compound having a slower gelation reaction rate than the at least one first metal compound has been subjected to a gelation reaction. As a result, in addition to the above effects, phase separation can be made to occur such that the second phase is formed on the first phase.

Moreover, according to the projecting film of the present invention, if the projecting parts have a diameter larger than the wavelength of visible light, then in addition to the above effects, the projecting film can be used as an internal scattering layer that scatters visible light.

Moreover, according to the projecting film of the present invention, if the projecting film has an average surface roughness Ra in a range of 10 to 1000 nm, preferably 10 to 300 nm, more preferably 20 to 200 nm, then the diameter of the projecting parts can be made to be larger than the wavelength of visible light, and hence the projecting film can be used as an internal scattering layer, and as a result, in addition to the above effects, a projecting shape suitable for scattering reflected light can be exhibited.

Moreover, according to the projecting film of the present invention, if the projecting film has a maximum surface roughness Rmax of not more than 10 μm, preferably not more than 3 μm, more preferably not more than 1.5 μm, then in addition to the above effects, in the case that the projecting film is used on a light-scattering/reflecting substrate of a liquid crystal display apparatus, even though the reflecting film coated onto the surface of the projecting film must be flattened using an overcoat, the overcoat need not be thick, and moreover the projecting film can be made to exhibit a projecting shape suitable for scattering light.

Moreover, according to the projecting film of the present invention, if the haze factor is not less than 1%, preferably not less than 2%, more preferably not less than 5%, then in addition to the above effects, the projecting film can be made to exhibit a projecting shape suitable for scattering light.

Moreover, according to the projecting film of the present invention, if the transmitted color tone value, as represented by |a²+b²|, the square of the vector sum of the Hunter color coordinates (a,b), is not more than 10, not more than, preferably not more than 5, then in addition to the above effects, transmitted light will not be colored, and hence a projecting film ideal for use in a transmission mode can be formed.

Moreover, according to the projecting film of the present invention, if the angle distribution of scattered transmitted light in response to visible light being perpendicularly incident on the projecting film is within a range of ±20° in terms of solid angle, then in addition to the above effects, a semi-transmission type LCD that exhibits bright displayed images by concentrating external light in the viewing direction can be realized, and as a result a projecting film suitable for scattering transmitted light can be formed.

Moreover, according to the projecting film of the present invention, if the scattering angle distribution of reflected light in response to visible light being perpendicularly incident on the projecting film is within a range of ±40° in terms of solid angle from the angle of specular reflection, then in addition to the above effects, a semi-transmission type LCD that exhibits bright displayed images by concentrating external light in the viewing direction can be realized, and as a result a projecting film suitable for scattering reflected light can be formed. Furthermore, back-scattering will not be prone to occurring, and hence the projecting film may also be used on a transmitting/diffusing plate provided in a rear projection type TV display or the like. Moreover, because the reflectance of light can be controlled, the projecting film may also be used as an anti-glare film, or may be used on a low-friction plate by being formed on the surface of an original-placing window of a copying machine, a side window of an automobile or the like.

Moreover, according to the method of forming a projecting film of the present invention, a projecting film can formed through few steps, specifically a step of forming an applied layer by applying a sol-form application liquid having mixed therein at least one first metal compound, at least one second metal compound, and at least one solvent, and a step of drying the applied layer. As a result, the manufacturing cost can be reduced.

Moreover, according to the method of forming a projecting film of the present invention, the at least one second metal compound has a slower gelation reaction rate than the at least one first metal compound. As a result, in addition to the above effects, phase separation can be made to occur such that a second phase is formed on a first phase when the applied sol-form application liquid is solidified by the gelation reaction.

Moreover, according to the method of forming a projecting film of the present invention, the at least one second metal compound has a lower wettability than the at least one first metal compound. As a result, in addition to the above effects, the second phase can exude out on the surface of the first phase in the form of droplets, and can then solidify through the gelation reaction while still maintaining the droplet form. As a result, the shape of the second phase can be made to be a projecting shape suitable for scattering light.

Moreover, according to the method of forming a projecting film of the present invention, at least one solvent out of the at least one solvent is a single solvent selected from the group consisting of straight-chain glycols having a hydroxyl group at each end thereof represented by the general formula HO—(CH₂)ₙ—OH wherein 2≦n≦10, and polyhydric alcohols represented by the general formula HO—(CH₂)ₙ(CHOH)ₘ—OH wherein n≧2 and m≧1, or a mixed solvent thereof. As a result, in addition to the above effects, the phase separation can be carried out efficiently.

Moreover, according to the method of forming a projecting film of the present invention, each of the at least one first metal compound and the at least one second metal compound is a metal compound capable of undergoing a hydrolysis/condensation polymerization reaction. As a result, in addition to the above effects, the solidification of the applied sol-form application liquid by the gelation reaction can be promoted.

Moreover, according to the method of forming a projecting film of the present invention, each of the at least one first metal compound and the at least one second metal compound is an alkoxide of a metal selected from the group consisting of silicon, aluminum, titanium, zirconium and tantalum. As a result, in addition to the above effects, the metal compounds are readily obtainable, stable at normal temperatures and pressures, and non-toxic, and hence the process for manufacturing the light-scattering film can be simplified and the manufacturing cost can be reduced. In addition, the light-scattering film formed will not absorb light in the visible region, and hence a light-scattering/reflecting substrate having the light-scattering film is suitable for use in a semi-transmitting type LCD or a projection type display.

1. A projecting film that is formed on a substrate and has a large number of projecting parts by phase separation, the projecting film characterized by being made of an inorganic material.

2. A projecting film as claimed in claim 1, characterized by comprising a first phase formed on the substrate, and a second phase that is formed on a surface of said first phase and has said projecting parts.

3. A projecting film as claimed in claim 2, characterized in that said first phase contains a component in which at least one first metal compound has been solidified by a gelation reaction, and said second phase contains a component in which at least one second metal compound having a slower gelation reaction rate than said at least one first metal compound has been subjected to a gelation reaction.

4. A projecting film as claimed in claim 1, characterized in that said projecting parts of the projecting film have a diameter larger than a wavelength of visible light.

5. A projecting film as claimed in claim 1, characterized by having an average surface roughness Ra in a range of 10 to 1000 nm.

6. A projecting film as claimed in claim 5, characterized by having an average surface roughness Ra in a range of 10 to 300 nm.

7. A projecting film as claimed in claim 5 or 6, characterized by having an average surface roughness Ra in a range of 20 to 200 nm.

8. A projecting film as claimed in claim 1, characterized by having a maximum surface roughness Rmax of not more than 10 μm.

9. A projecting film as claimed in claim 8, characterized by having a maximum surface roughness Rmax of not more than 3 μm.

10. A projecting film as claimed in claim 8 or 9, characterized by having a maximum surface roughness Rmax of not more than 1.5 μm.

11. A projecting film as claimed in claim 1, characterized by having a haze factor not less than 1%.

12. A projecting film as claimed in claim 11, characterized by having a haze factor not less than 2%.

13. A projecting film as claimed in claim 11 or 12, characterized by having a haze factor not less than 1.5%.

14. A projecting film as claimed in any one of claims 1 through 6, characterized by having a transmitted color tone value, as represented by |a²+b²|, the square of the vector sum of Hunter color coordinates (a,b), of not more than 10.

15. A projecting film as claimed in claim 14, characterized by having a transmitted color tone value, as represented by of the vector sum of the Hunter color coordinates (a,b), of not more than 5.

16. A projecting film as claimed in any one of claims 1 through 6, characterized in that an angle distribution of scattered transmitted light in response to visible light being perpendicularly incident on the projecting film is within a range of ±20° in terms of solid angle.

17. A projecting film as claimed in claim 16, characterized in that a scattering angle distribution of reflected light in response to visible light being perpendicularly incident on the projecting film is within a range of ±40° in terms of solid angle from an angle of specular reflection.

18. A projecting film as claimed in any one of claims 1 through 6, characterized by being used as an internal scattering layer disposed in a reflection type liquid crystal display apparatus or a semi-transmission type liquid crystal display apparatus.

19. A projecting film as claimed in claim 1, characterized by being used on a transmitting/diffusing plate.

20. A projecting film as claimed in claim 1, characterized by being used as an anti-glare film.

21. A projecting film as claimed in claim 1, characterized by being formed on a surface of an original-placing window of a copying machine or a side window of an automobile.

22. A method of forming a projecting film, characterized by comprising:
a formation step of forming an applied layer by applying, onto the substrate, a sol-form application liquid having mixed therein at least one first metal compound, at least one second metal compound, and at least one solvent; and
a drying step of drying the applied layer to form a large number of projecting parts.

23. A method of forming a projecting film as claimed in claim 22, characterized in that the at least one second metal compound has a slower gelation reaction rate than the at least one first metal compound.

24. A method of forming a projecting film as claimed in claim 23, characterized in that the at least one second metal compound has a lower wettability than the at least one first metal compound.

25. A method of forming a projecting film as claimed in claim 22, characterized in that at least one solvent out of the at least one solvent is a single solvent selected from the group consisting of straight-chain glycols having a hydroxyl group at each end thereof represented by the general formula HO—(CH₂)ₙ—OH wherein 2≦n≦10, and polyhydric alcohols represented by the general formula HO—(CH₂)ₙ(CHOH)ₘ—OH wherein n≧2 and m≧1, or a mixed solvent thereof.

26. A method of forming a projecting film as claimed in claim 22, characterized in that each of the at least one first metal compound and the at least one second metal compound is a metal compound capable of undergoing a hydrolysis/condensation polymerization reaction.

27. A method of forming a projecting film as claimed in claim 26, characterized in that each of the at least one first metal compound and the at least one second metal compound is an alkoxide of a metal selected from the group consisting of silicon, aluminum, titanium, zirconium and tantalum.
